(19) United States
(12) Patent Application Publication
(10) Pub. No.: US 2007/0266372 A1
(43) Pub. Date: Nov. 15, 2007

(54) GENERATING DOCUMENTATION FROM TASK EXECUTION

(76) Inventors: Helen L. Gawor, Apex, NC (US); Steven D. Ims, Raleigh, NC (US); Julie H. King, Raleigh, NC (US); Dinesh C. Verma, New Castle, NY (US)

Correspondence Address: HOFFMAN WARNICK & DALESSANDRO LLC, 75 STATE ST, 14TH FLOOR, ALBANY, NY, 12207, US

(21) Appl. No.: 11/382,551

(22) Filed: May 10, 2006

(51) Int. Cl. G06F 9/44

(52) U.S. Cl. 717/123

(57) ABSTRACT

A method, system and computer program product for generating documentation of a customized execution of a task of a process are disclosed. A documentation program is associated with the task. When the task is executed, an execution time of the task execution is detected, which triggers an execution of the documentation program. In the case that a process includes multiple tasks, documentation of the multiple tasks is generated in an order based on the detected execution times of the multiple tasks within the process.

### FIELD OF THE INVENTION

The invention relates generally to generating documentation of a process, and more particularly to generating documentation of a task of a process based on a detected run time of the execution of the task.

### BACKGROUND OF THE INVENTION

When a program or solution is installed and configured to be executed in a computer system, multiple manual steps need to be taken to make the program/solution executable. Usually, documentation, e.g., instructions for performing the steps, needs to be created by someone at sometime to record the details of the manual steps so that these steps can be duplicated later on. Such separately created documentation has inherent disadvantages. For example, separately created instructions may miss some steps because they are assumed to be obvious or straightforward. In addition, separately created instructions may miss information or include incorrect information regarding the details of the steps. Moreover, further changes may be made to the steps, which may not be reflected in the initial documentation. As a consequence, when someone tries to carry out the documented instructions manually or create an automated process to carry them out, the program/solution will not work as desired.

Day et al. (U.S. Pat. No. 5,953,526) provide an approach to generate documentation of a programming object of an object oriented programming system through a separate documentation programming object. In Day et al., the basic documentation provided for the object oriented program may be modified without changing the framework of the programming objects, due to the separate documentation programming object. However, in Day et al., the creation of documentation is still disengaged/separate from the execution of the object oriented program, which does not avoid the disadvantages described above.

Based on the above, it is preferable that generation of documentation be associated with the execution of a process so that the generated documentation reflects the real scenario of the execution. The present state of the art technology does not provide a successful solution to this question. As such, there is a need for generating documentation of a task based on a run time of an execution of the task.

### BRIEF SUMMARY OF THE INVENTION

A method, system and computer program product for generating documentation of a customized execution of a task of a process are disclosed. A documentation program is associated with the task. When the task is executed, an execution time of the task execution is detected, which triggers an execution of the documentation program. In the case that a process includes multiple tasks, documentation of the multiple tasks is generated in an order based on the detected execution times of the multiple tasks within the process.

A first aspect of the invention is directed to a method for generating documentation for a customized execution of a task of a process, the method comprising: associating a documentation program with the task; detecting information of the customized execution of the task; retrieving the documentation program upon detecting the execution information; and generating documentation of the customized execution of the task by executing the documentation program.

A second aspect of the invention is directed to a computer program product for generating documentation for a customized execution of a task of a process, the task being associated with a documentation program, the computer program product comprising: computer usable program code configured to: receive detected information of the customized execution of the task; retrieve the documentation program upon receipt of the detected execution information; and generate documentation of the customized execution of the task by executing the documentation program.

A third aspect of the invention is directed to a system for generating documentation for a customized execution of a task of a process, the task being associated with a documentation program, the system comprising: means for detecting information of the customized execution of the task; means for retrieving the documentation program upon detecting the execution information; and means for generating documentation of the customized execution of the task by executing the documentation program.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

The embodiments of this invention will be described in detail, with reference to the following figures, wherein:

FIG. 1 shows a schematic view of an illustrative documentation system, according to one embodiment of the invention.

FIG. 2 shows a block diagram of an illustrative computer system, according to one embodiment of the invention

FIG. 3 shows one embodiment of an operation of a documentation generator, according to the invention.

It is noted that the drawings of the invention are not to scale. The drawings are intended to depict only typical aspects of the invention, and therefore should not be considered as limiting the scope of the invention. In the drawings, like numbering represents like elements among the drawings.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

### 1. General Description

The current invention overcomes the deficiencies of the prior art by associating the generation of documentation directly with a customized execution of a task. Specifically, according to one embodiment, each step/task of a process is associated with a corresponding documentation program, e.g., a documentation snippet, which describes the step/task in human-understandable terms. In the following description, a documentation snippet will be used as an illustrative example of a documentation program. In addition, an instruction (or instructions) on how to execute a task will be used as an illustrative example of documentation. The documentation snippet may be executed conjunctly with an execution of the associated task of a process. For example, according to one embodiment, the execution of a documentation snippet is triggered by an execution of the associated task. For a process that includes multiple tasks/steps, the execution of a documentation snippet for each task of the process is triggered by the execution of the task, and thus documentation of customized executions of the multiple tasks is performed in an order based on an execution sequence of the multiple tasks. By executing the documentation snippets, a complete set of documentation, e.g., instructions, may be generated in the order that the multiple tasks of the process are executed within the process. In addition, a documentation snippet may also describe the associated task with respect to another task logically related to the associated task. For example, a task “A” may be logically related to another task “B” in that an execution of task “A” invokes execution of task “B” coincidentally. In this case, documentation snippet of task “A” may stipulate/instruct/implement generating documentation for task “B” substantially coincidentally with the documentation generation of task “A”. Various methods may be used to associate a documentation snippet to a step/task of a process, and all are included in the current invention. For example, the documentation snippet may be incorporated in the file of the task as a comment defining the task, or may be tied to the task by some identifier.

By associating the execution of each documentation snippet directly with the execution of the corresponding/associated step/task, it is guaranteed that no instruction is left out, and that the order of the instructions is correct. In addition, as each documentation snippet is associated directly with the corresponding step/task in execution, the generated instructions may also reflect a customized property of the execution, e.g., a particular environment and parameters, of the execution, as the instructions are only generated for the steps/tasks actually executed under the specific environment and with the specific parameters. For example, in the case that a process has different steps to be executed on Windows™ (available from Microsoft™ Corporation) or Linux® (available from Linus Torvalds) environments, and the process is actually executed on the Windows™, only the instructions for the execution on the Windows™ environment will be documented. According to one embodiment, documentation snippets can be customized so that they reflect the actual information available at the execution of a process. For example, a documentation snippet may include placeholders for parameters that can be replaced during each customized execution of the corresponding/associated task/step.

Using this method, documentation will always match the associated process in execution, even if the process is modified in execution by adding or removing steps, or otherwise changing the steps. It creates instructions that are customized for the particular customized execution. Once documentation of a particular task is generated correctly once, it does not need to be generated again, and may be saved in a pre-built library of documentation for later reference and retrieval. This improves consistency of the documentation process and saves system resources. In the following description, a system for implementing the invention will be described.

### 2. System Overview

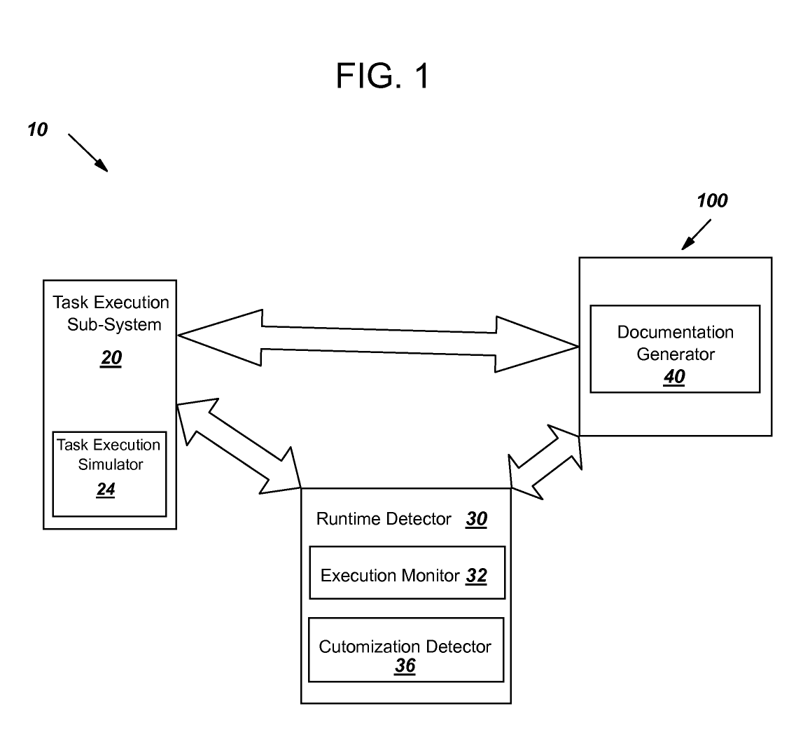

Referring to FIG. 1, a schematic view of an illustrative documentation system 10 is shown. According to one embodiment, documentation system 10 includes a task execution sub-system 20, a runtime detector 30, and a documentation generator 40. Task execution sub-system 20 may include a task execution simulator 24 that functions to simulate an execution of a task. Any now available or later developed methods may be used to implement task execution simulator 24, and all are included in the current invention. Runtime detector 30 functions to detect details of a real execution/simulated execution (execution details/execution information) of a task in task execution sub-system 20, and communicate the same to documentation generator 40. Examples of the execution details include the time when the execution of the task starts and finishes, and the environment and parameters of the execution of the task. According to one embodiment, runtime detector 30 monitors in real time an execution of a task. Specifically, execution monitor 32 of runtime detector 30 may hook to the execution of the task to monitor the execution details. For some tasks, such a hook is conveniently available as execution monitor 32 may share the hook of a debugger of the task file. It should be appreciated that other methods of monitoring in real time the execution of a task are also included in the current invention.

According to an alternative embodiment, especially in the cases that a readily available hook, e.g., that of a debugger, does not exist, execution monitor 32 may monitor a simulated execution of a task by task execution simulator 24. It should be appreciated that task execution simulator 24 may not be capable of simulating a customized property of the execution, e.g., execution environment and/or parameters, because such information may only be available from a real execution. In this case, customization detector 36 of runtime detector 30 may be used to obtain a customized property of the customized execution, which may be combined with the detected execution simulation of task execution simulator 24 to be communicated to documentation generator 40.

It should be appreciated that components/units of documentation system 10 may be located in a single physical location, or may be located in separate physical locations. In the latter situation, any now known or later developed methods may be used to communicate data between/among the units located in remote locations, and all are included in the current invention.

According to one embodiment, documentation generator 40 may reside in a computer system 100, which will be described in detail below.

### 3. Computer System

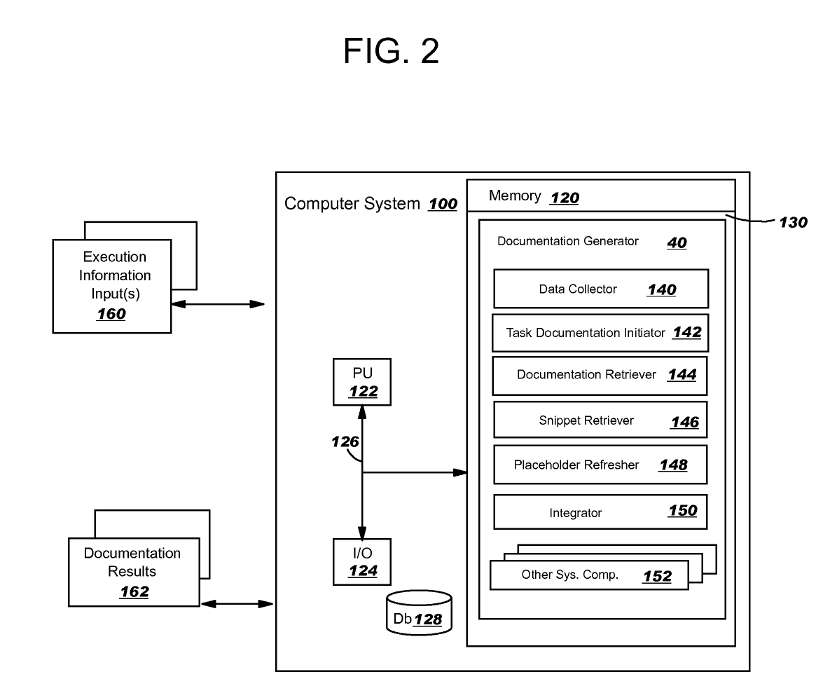

Referring to FIG. 2, a block diagram of an illustrative computer system 100 is shown. In one embodiment, computer system 100 includes a memory 120, a processing unit (PU) 122, input/output devices (I/O) 124 and a bus 126. A database 128 may also be provided for storage of data relative to processing tasks. Memory 120 includes a program product 130 that, when executed by PU 122, comprises various functional capabilities described in further detail below. Memory 120 (and database 128) may comprise any known type of data storage system and/or transmission media, including magnetic media, optical media, random access memory (RAM), read only memory (ROM), a data target, etc. Moreover, memory 120 (and database 128) may reside at a single physical location comprising one or more types of data storage, or be distributed across a plurality of physical systems. PU 122 may likewise comprise a single processing unit, or a plurality of processing units distributed across one or more locations. I/O 124 may comprise any known type of input/output device including a network system, modem, keyboard, mouse, scanner, voice recognition system, CRT, printer, disc drives, etc. Additional components, such as cache memory, communication systems, system software, etc., may also be incorporated into computer system 100.

As shown in FIG. 2, program product 130 may include documentation generator 40 that includes a data collector 140; a task documentation initiator 142; a documentation retriever 144; a snippet retriever 146; a placeholder refresher 148; an integrator 150; and other system components 152. Other system components 152 may include any now known or later developed parts of a computer system 100 not individually delineated herein, but understood by those skilled in the art.

Inputs to computer system 100 include execution information inputs 160, which include the execution data obtained by runtime detector 30 (FIG. 1). Those inputs may be communicated to computer system 100 through I/O 124 and may be collected by data collector 140 and stored in database 128. Outputs of computer system 100 include documentation results 162, e.g., instructions for executing a task, that are communicated to, inter alia, a user to follow the instructions in duplicating the execution later on. The operation of documentation generator 40 will be described in detail below.

### 4. Documentation Generator

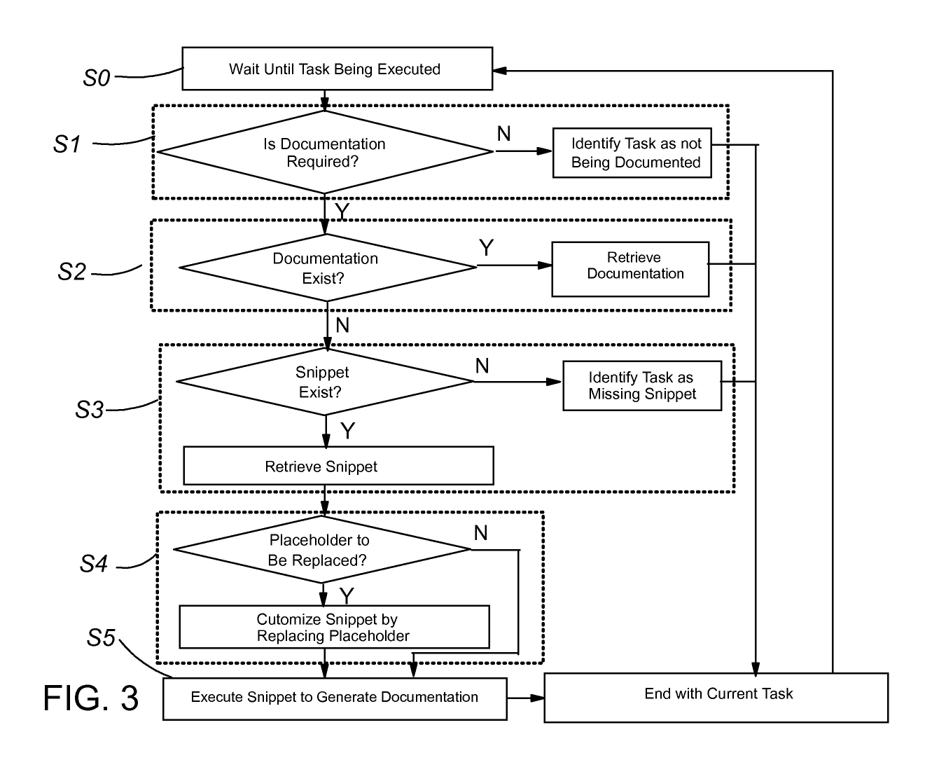

Documentation generator 40 functions generally to generate documentation, e.g., instructions, of a task of a process executed in task execution sub-system 20 (FIG. 1) based on the execution information obtained by runtime detector 30. One embodiment of the operation of documentation generator 40 is shown in the flow diagram of FIG. 3. In the following description of the flow diagram, it is assumed that execution monitor 32 of runtime detector 30 monitors in real time an actual execution of a task in task execution sub-system 20, for illustrative purpose. It should be appreciated that other ways of detecting execution information of a task, e.g., simulating an execution of a task, are also included in the invention.

According to one embodiment, documentation generator 40 may preset a documentation structure file for a process that includes multiple tasks. Documentation, e.g., instructions, of a task of the multiple tasks will be integrated into the structure file as will be described later. The instructions of the multiple tasks may be ordered in the documentation structure file of the process based on the execution times of the multiple tasks. For example, if task “A” is executed before task “B” of a process, instructions for executing task “A” will show in the documentation structure file earlier than that of task “B”.

Referring now to FIGS. 2-3, in step S0, operation of documentation generator 40 idles to wait for a task being executed on task execution sub-system 20 (FIG. 1). As described above, the operation of documentation generator 40 may be triggered by the execution of a task, e.g., task “A”, in task execution sub-system 20. Specifically, according to one embodiment, execution monitor 32 (FIG. 1) of runtime detector 30 monitors the starting time of an execution of task “A” on task execution sub-system 20 and communicates the information to data collector 140. Upon receiving the information, operation of documentation generator 40 starts and proceeds to the next step, step S1.

Next, in step S1, task documentation initiator 142 determines whether documentation is required for the task executed on task execution sub-system 20 (FIG. 1). Documentation of a task execution may not always be preferred. For example, there may be cases where a task (step) may prefer turning off the documentation of all its child tasks. For example, a task may create a new Java™ Database Connectivity (JDBC)™ (available from Sun Microsystems, Inc) provider for WebSphere® Application Server (WAS) (available from International Business Machines Corporation) using a Java™ Command Language (JACL) script through WAS wsadmin tool. However, this task may not prefer the wsadmin task (child task) to generate documentation, e.g., instructions, because the instructions wsadmin will generate are for using the admin console, not for using wsadmin. For another example, there may be cases that a parent task does not need documentation, while a child task of the parent task does.

If it is determined that task “A” does not require documentation, task documentation initiator 142 identified in the right location of the documentation structure file of the process, i.e., the location determined based on the execution time of task “A”, that documentation is not generated for task A, and the operation of documentation generator 40 ends with task A and goes back to step S0 to wait for the execution of a next task to be executed in task execution sub-system 20 (FIG. 1). It should be appreciated that the next task could be a child task of task “A”. If it is determined that task A requires documentation, the operation of documentation generator 40 proceeds to step S2.

Next in step S2, documentation retriever 144 retrieves documentation that already exist for task A. Specifically, documentation retriever 144 first determines whether documentation, e.g., instructions, exists for the customized execution of task “A”, e.g., in a cache. As has been described above, if documentation for the execution of task “A” had been generated before, it does not need to be generated again. It should be noted that an execution of a task may be customized with respect to, e.g., execution environment and/or parameters. As such, in determining whether documentation exists for task A, documentation retriever 144 considers the customized properties of the execution of task “A”. If it is determined that documentation exists for task “A”, e.g., in a cache, documentation retriever 144 retrieves the documentation, e.g., from the cache, and the operation of documentation generator 40 ends with task “A”. If it is determined that documentation does not exist for task A, the operation of documentation generator 40 proceeds to the next step.

Next in step S3, snippet retriever 146 retrieves a documentation snippet for task “A”. Specifically, snippet retriever 146 first determines whether a documentation snippet for task “A” exists. If it is determined that a documentation snippet does not exist, snippet retriever 146 may identify an error in the right position of the documentation structure file of the process. For example, snippet retriever 146 may tag task “A” as missing a documentation snippet in a position of the documentation structure file that is determined based on the execution time of task “A”. As such, a user may, e.g., manually add instructions accordingly later on. If it is determined that a documentation snippet exists for task “A”, snippet retriever 146 retrieves the same, and the operation of documentation generator 40 proceeds to the next step.

Next in step S4, placeholder refresher 148 customizes the retrieved documentation snippet based on a detected customized property of the customized execution of task “A”. Specifically, placeholder refresher 148 first determines whether the documentation snippet includes a placeholder to be refreshed. If it is determined that the documentation snippet includes such a placeholder, placeholder refresher 148 replaces the placeholder based on the execution information, e.g., a customized property of the execution of task “A”, communicated from runtime detector 30 (FIG. 1), and the operation of documentation generator 40 proceeds to the next step S5. Please note, as has been described above, runtime detector 30 detects a customized property of the execution of task “A”, e.g., execution environment and/or parameters, which is communicated to computer system 100 and is collected by data collector 140. If it is determined that the documentation snippet does not include a placeholder to be replaced, the operation of documentation generator 40 proceeds directly to step S5.

Next in step S5, integrator 150 generates documentation of task “A” by executing the documentation snippet and integrates the generated documentation into the documentation structure file of the process. Specifically, according to one embodiment, integrator 150 adds the retrieved snippet for task “A” to the documentation structure file for the process, which may executed any time to generate a complete set of documentation for the whole process. According to an alternative embodiment, integrator 150 executes the retrieved snippet for task “A” and adds the generated documentation of task “A” to the documentation structure file for the whole process. In addition, as described above, documentation snippet of task A may instruct/implement generating documentation of another different task that is logically related to task A, e.g., a supporting task, substantially coincidentally with the documentation generation of task A. Then, the operation of documentation generator 40 ends with task “A” and proceeds to the next task.

In the following, an example of implementing the current invention is provided for illustrative purposes. This specific example of documentation generation uses Apache Ant, a Java™-based build tool available from Apache Software Foundation (http://ant.apache.org), to execute an automated task. In its latest version, Apache Ant introduces the concept of macrodefs, a light-weight mechanism for defining new tasks. When a macrodef is defined, a comment may be asserted to act as a documentation snippet to describe a task. e.g.

<!--

<LI>Open the WebSphere Application Server.</LI>
<LI>In <B>Environment > Manage WebSphere Variables</B>:

<UL><LI>Set the @{varName} variable to @
{varValue}</LI></UL>

</LI>
@processChildComments=false -->

<macrodef name=“setVarSub” uri=“was-5”>

<attribute name=“varName” description=“the

variable name to create or modify” />

<attribute name=“varValue” description=“the new

value for the variable” />

...

</macrodef>

There are some things to note about the comment, i.e., documentation snippet. First, formatting information is expressed in the comment as Hyper Text Markup Language (HTML) tags. Second, placeholders have been inserted such as @{varName} that map to the attributes defined for this macrodef (the arguments this task takes). Lastly, the comment has a @processChildComments=false tag to indicate that it does not want its child tasks to be documented.

The appropriate hook into the Ant execution time is achieved by implementing a build listener. The build listener, when registered with Ant, receives notification of events such as task starting and ending. The build listener also has access to the execution time context to be able to resolve variables. As the execution starts, the build listener receives notification of each of the macrodefs that has been defined. For each one, the build listener is able to receive a reference to the file where it is defined. The build listener then retrieves the contents of that file, parses it using an Extensible Markup Language (XML) parser, retrieves the first comment above the given macrodef, and caches it. Next, when the build listener receives an event that a task has started, it first checks to see if it is currently generating documentation. If it is, the build listener searches the cache to see if there is a stored comment for that task. If yes, it then searches for any @{symbols that indicate a placeholder to be replaced, and for each such placeholder it finds, the build listener looks up the variable in the runtime context and replaces the placeholder with the correct value. It then adds this documentation snippet to the generated documentation. Lastly, it looks for the processChildComments=false tag to see if it should turn the documentation generation operation off for any child tasks.

The finished documentation looks like this:

<LI>Open the WebSphere Application Server.</LI>
<LI>In <B>Environment > Manage WebSphere Variables</B>:

<UL><LI>Set the MQ_INSTALL_ROOT variable to

C:/Progra˜1/WebSphere/MQ</LI
></UL></LI>

After the documentation is generated it may require additional post processing as it can become repetitive, but as long as each documentation snippet has been defined correctly the generated documentation is guaranteed to match the automated process, therefore eliminating the problems caused by the disconnection between the automated process and documentation.

### 5. Conclusion

While shown and described herein as a method and system for generating documentation for a customized execution of a task of a process, it is understood that the invention further provides various alternative embodiments. For example, in one embodiment, the invention provides a program product stored on a computer-readable medium, which when executed, enables a computer infrastructure to generate documentation for a customized execution of a task of a process. To this extent, the computer-readable medium includes program code, such as documentation generator 40 (FIG. 2), which implements the process described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 120 (FIG. 2) and/or database 128 (FIG. 2), and/or as a data signal traveling over a network (e.g., during a wired/wireless electronic distribution of the program product).

In another embodiment, the invention provides a method of generating a system for generating documentation for a customized execution of a task of a process. In this case, a computer infrastructure, such as computer system 100 (FIG. 2), can be obtained (e.g., created, maintained, having made available to, etc.) and one or more systems for performing the process described herein can be obtained (e.g., created, purchased, used, modified, etc.) and deployed to the computer infrastructure. To this extent, the deployment of each system can comprise one or more of: (1) installing program code on a computing device, such as computing system 100 (FIG. 2), from a computer-readable medium; (2) adding one or more computing devices to the computer infrastructure; and (3) incorporating and/or modifying one or more existing systems of the computer infrastructure, to enable the computer infrastructure to perform the process steps of the invention.

In still another embodiment, the invention provides a business method that performs the process described herein on a subscription, advertising supported, and/or fee basis. That is, a service provider could offer to generate documentation for a customized execution of a task of a process as described herein. In this case, the service provider can manage (e.g., create, maintain, support, etc.) a computer infrastructure, such as computer system 100 (FIG. 2), that performs the process described herein for one or more customers and communicates the results of the evaluation to the one or more customers. In return, the service provider can receive payment from the customer(s) under a subscription and/or fee agreement and/or the service provider can receive payment from the sale of advertising to one or more third parties.

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that the terms “component” and “system” are synonymous as used herein and represent any combination of hardware and/or software capable of performing some function(s).

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method for generating documentation for a customized execution of a task of a process, the method comprising:
associating a documentation program with the task;
detecting information of the customized execution of the task;
retrieving the documentation program upon detecting the execution information; and
generating documentation of the customized execution of the task by executing the documentation program.

2. The method of claim 1, wherein the process includes multiple tasks, and wherein documentation of customized executions of the multiple tasks is generated in an order based on a detected execution sequence of the multiple tasks.

3. The method of claim 1, further including identifying the task as not being documented upon detecting the execution information of the customized execution of the task

4. The method of claim 1, wherein the execution information detecting step further includes detecting a customized property of the customized execution of the task.

5. The method of claim 4, further including customizing the documentation program based on the detected customized property of the customized execution.

6. The method of claim 1, wherein the execution information detecting step includes at least one of:
monitoring in real time the customized execution of the task; and
simulating the customized execution of the task.

7. The method of claim 1, further including retrieving documentation of the customized execution of the task that already exists at a time of the customized execution.

8. The method of claim 1, wherein the documentation generation step further includes generating documentation of a customized execution of another task, said another task being logically related to the task.

9. A computer program product for generating documentation for a customized execution of a task of a process, the task being associated with a documentation program, the computer program product comprising:
computer usable program code configured to:
receive detected information of the customized execution of the task;
retrieve the documentation program upon receipt of the detected execution information; and
generate documentation of the customized execution of the task by executing the documentation program.

10. The program product of claim 9, wherein the process includes multiple tasks, and wherein documentation of customized executions of the multiple tasks is generated in an order based on a detected execution sequence of the multiple tasks.

11. The program product of claim 9, wherein the program code is further configured to receive a detected customized property of the customized execution of the task.

12. The program product of claim 11, wherein the program code is further configured to customize the documentation program based on the detected customized property of the customized execution.

13. The program product of claim 9, wherein the information of the customized execution is detected using at least one of:
monitoring in real time the customized execution of the task; and
simulating the customized execution of the task.

14. The program product of claim 9, wherein the program code is further configured to retrieve documentation of the customized execution of the task that already exists at a time of the customized execution.

15. The program product of claim 9, wherein the program code is further configured to generate documentation of a customized execution of another task, said another task being logically related to the task.

16. A system for generating documentation for a customized execution of a task of a process, the task being associated with a documentation program, the system comprising:
means for detecting information of the customized execution of the task;
means for retrieving the documentation program upon detecting the execution information; and
means for generating documentation of the customized execution of the task by executing the documentation program.

17. The system of claim 16, wherein the process includes multiple tasks, and wherein documentation of customized executions of the multiple tasks is generated in an order based on a detected execution sequence of the multiple tasks.

18. The system of claim 16, wherein the execution information detecting means further detects a customized property of the customized execution of the task.

19. The system of claim 18, further including means for customizing the documentation program based on the detected customized property of the customized execution.

20. The system of claim 15, wherein the execution information detecting means performs at least one of:
monitoring in real time the customized execution of the task; and
monitoring a simulated customized execution of the task.
